(19) United States
(12) Patent Application Publication
(10) Pub. No.: US 2008/0149886 A1
(43) Pub. Date: Jun. 26, 2008

(54) ETCHANT FOR ETCHING WORKPIECES MADE OF ALUMINUM AND ALUMINUM ALLOY

(75) Inventors: CHIH-PEN LIN, Shindian (TW); NIAN-JIANG WU, Shenzhen (CN); QING-SONG CAO, Shenzhen (CN); NAN-HAI LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRIAL CO.,LTD., Shenzhen (CN); SUTECH TRADING LIMITED, Tortola (VG)

(21) Appl. No.: 11/752,906

(22) Filed: May 23, 2007

(30) Foreign Application Priority Data
Dec. 22, 2006 (CN) 200610157863.5

(51) Int. Cl. C09K 13/06; C09K 13/04

(52) U.S. Cl. 252/79.4; 252/79.2

(57) ABSTRACT

An etchant includes ferric ions (Fe³⁺) and hydrochloric acid (HCl). The ferric ions (Fe³⁺) have a concentration in the approximate range of 30-70 grams/liter (g/l). The hydrochloric acid (HCl) has a concentration in the approximate range of 16-50 grams/liter (g/l). The resultant etchant is particularly suitable for etching aluminum and its alloys but may be useful for other etching situations.

### BACKGROUND OF THE INVENTION

1. Field of the Invention

The present invention relates to an etchant, and, particularly, to a kind of etchant well-suited for etching workpieces made of aluminum or an aluminum alloy.

2. Description of Related Art

Workpieces made of aluminum or an aluminum alloy are widely used in modern industry. In use, workpieces made of aluminum or an aluminum alloy are oftentimes etched to form apertures, marks, and/or designs on/in surfaces thereof. A typical etchant includes a ferric chloride (FeCl₃) solution, in which a concentration of FeCl₃ is 120-180 gram/liter (g/l). When this etchant is used to etch workpieces made of aluminum and aluminum alloy, ferric ions (Fe³⁺) of the etchant oxidize aluminum atoms to yield aluminum ions (Al³⁺), and the ferric ions (Fe³⁺) are reduced to ferrous ions (Fe²⁺). The equation of the etching process is described as follows:

3FeCl₃+Al=3FeCl₂+AlCl₃

However, because aluminum has a higher level of reactivity than iron, when the typical etchant etches workpieces made of aluminum or aluminum alloy according to the aforementioned equation, a substitution reaction also occurs. In this substitution reaction, the ferric ions (Fe³⁺) and ferrous ions (Fe²⁺) are reduced to be iron by aluminum atoms. An equation demonstrating this process is as follows:

FeCl₃+Al→Fe+AlCl₃

3FeCl₂+2Al→3Fe+2AlCl₃

However, as the workpieces are etched, a layer of iron powder may be formed on various surfaces of the workpieces, and such iron powder may interfere with the etching process. Additionally, because of the high concentration of the FeCl₃ used in this process it can be hard to control the degree to which the work pieces are etched.

Therefore, a kind of new etchant, used to etch workpieces made up of aluminum or an aluminum alloy, is desired in order to overcome the above-described shortcomings.

### SUMMARY

An etchant includes a solution including ferric ions (Fe³⁺) and hydrochloric acid (HCl), wherein the ferric ions (Fe³⁺) are present in a concentration in the approximate range from 30-70 grams/liter (g/l) and the hydrochloric acid (HCl) is present in a concentration in the approximate range of 16-50 grams/liter (g/l).

Other advantages and novel features will become more apparent from the following detailed description when taken in conjunction with the accompanying drawings.

### BRIEF DESCRIPTION OF THE DRAWING

Many aspects of the present etchant system can be better understood with reference to the following drawing. The components in the drawing are not necessarily drawn to scale, the emphasis instead being placed upon clearly illustrating the principles of the present etchant system. Moreover, in the drawing, like reference numerals designate corresponding parts throughout the diagram.

The drawing is a perspective view of a testing workpiece used to test etching quality of the etchant in accordance with the first, the second, and the third embodiments of the present etchant system.

### DETAILED DESCRIPTION OF THE INVENTION

Referring now to the detail, a first etchant in accordance with a first embodiment is provided. The first etchant is applied to workpieces made of aluminum or an aluminum alloy, such as housings of mobile phones, computers, digital cameras, etc., in order to form apertures, marks, and/or designs therein. The first etchant includes ferric chloride (FeCl₃) solution and hydrochloric acid (HCl). Beneficially, the concentration of FeCl₃ is about 50 grams/liter (g/l), and the concentration of HCl is about 30 g/l.

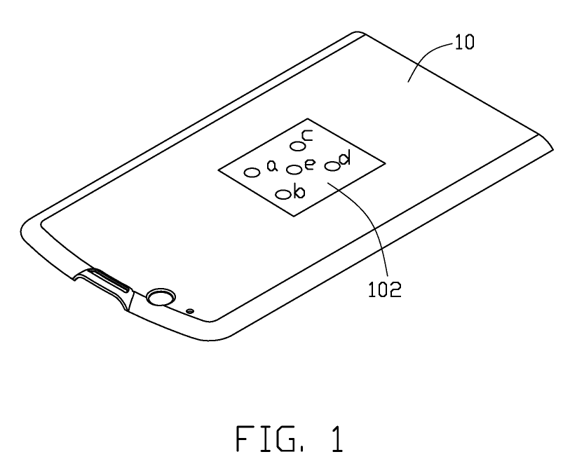

Referring to FIG. 1, a plurality of test workpieces 10 is provided (one of which is shown). The test workpiece 10 includes a test surface 102. Referring to Table 1, the first etchant is used to etch twenty test workpieces 10 in a given test. Areas designated by a, b, c, d and e on the test surface 102 of each test workpiece 10 are etched using the first etchant. The etching process is described as follows:

3FeCl₃+Al→3FeCl₂+AlCl₃

Because aluminum has a higher level of chemical reactivity than iron, when the first etchant etches the test workpieces 10 according to the aforementioned equation, a substitution reaction also occurs. In this substitution reaction, the ferric ions (Fe³⁺) and ferrous ions (Fe²⁺) are reduced by the aluminum atoms to ultimately form iron atoms. The substitution reaction is described as follows:

FeCl₃+Al→Fe+AlCl₃

3FeCl₂+2Al→3Fe+2AlCl₃

When the test workpieces 10 are etched, iron powder is formed on the test surfaces 102 of the test workpieces 10. However, the first etchant includes adequate amounts of HCl to dissolve the iron powder. The dissolution process is described as follows:

Fe+2HCl→FeCl₂+H₂↑

In this way, formation of a layer of iron powder on the test surfaces 102 of the test workpieces 10 is precluded, thus the etching process can be completed successfully. The etching depths in millimeters in each area a, b, c, d and e of each test workpiece 10 is described in Table 1 as follows:

TABLE 1

| | place | | | | | |
|---|---|---|---|---|---|---|
| testing workpiece | a | b | c | d | e | tolerance |
| I | 0.107 | 0.109 | 0.098 | 0.105 | 0.112 | 0.007 |
| II | 0.111 | 0.102 | 0.102 | 0.105 | 0.106 | 0.009 |
| III | 0.102 | 0.106 | 0.110 | 0.111 | 0.105 | 0.009 |
| IV | 0.105 | 0.115 | 0.102 | 0.112 | 0.115 | 0.013 |
| V | 0.112 | 0.102 | 0.106 | 0.112 | 0.105 | 0.010 |
| VI | 0.115 | 0.102 | 0.106 | 0.109 | 0.105 | 0.013 |
| VII | 0.104 | 0.106 | 0.099 | 0.105 | 0.098 | 0.008 |
| VIII | 0.103 | 0.112 | 0.105 | 0.105 | 0.109 | 0.009 |
| IX | 0.099 | 0.101 | 0.102 | 0.098 | 0.104 | 0.006 |
| X | 0.097 | 0.101 | 0.105 | 0.097 | 0.104 | 0.008 |
| XI | 0.104 | 0.110 | 0.108 | 0.102 | 0.105 | 0.008 |
| XII | 0.108 | 0.102 | 0.099 | 0.105 | 0.110 | 0.011 |
| XIII | 0.110 | 0.112 | 0.115 | 0.116 | 0.116 | 0.006 |
| XIV | 0.113 | 0.114 | 0.118 | 0.117 | 0.119 | 0.006 |
| XV | 0.115 | 0.112 | 0.119 | 0.116 | 0.109 | 0.010 |
| XVI | 0.105 | 0.112 | 0.115 | 0.109 | 0.119 | 0.014 |
| XVII | 0.102 | 0.101 | 0.098 | 0.102 | 0.108 | 0.010 |
| XVIII | 0.107 | 0.110 | 0.102 | 0.102 | 0.104 | 0.008 |
| XIX | 0.105 | 0.102 | 0.102 | 0.105 | 0.099 | 0.006 |
| XX | 0.102 | 0.102 | 0.108 | 0.105 | 0.109 | 0.007 |
| maximum | 0.115 | 0.115 | 0.119 | 0.117 | 0.119 | 0.013 |
| minimum | 0.097 | 0.101 | 0.098 | 0.097 | 0.098 | 0.006 |
| tolerance | 0.018 | 0.014 | 0.021 | 0.020 | 0.021 | — |
| average | 0.106 | 0.107 | 0.106 | 0.107 | 0.108 | 0.009 |

In Table 1, the largest etching depth in any one of all the test workpieces 10 is roughly 0.014 millimeters, and the largest etching depth in all test workpieces 10 is roughly 0.021 millimeters. In production, a tolerance of the etching depths in workpieces made of aluminum or an aluminum alloy, such as housings of mobile phones, computers, digital cameras, etc, is required to be smaller than 0.03 millimeters. Therefore, when the first etchant is used to etch workpieces made of aluminum or an aluminum alloy, the etching quality is consistently within this tolerance.

A second etchant in accordance with a second embodiment is also provided. The second etchant has the same use as the aforementioned first etchant. The second etchant is made up of includes FeCl₃ solution and HCl. Usefully, the concentration of FeCl₃ is about 30 g/l, while that of HCl is about 16 g/l.

Referring to Table 2, the second etchant is also tested to etch twenty test workpieces 10. The areas a, b, c, d and e on the test surface 102 of each testing workpiece 10 are etched by the second etchant in a given test. The etching process of testing the second etchant has the same equations as that of testing employing the first etchant. Etching depths in millimeters in each position on each test workpiece 10 is described in Table 2, as follows:

TABLE 2

| | place | | | | | |
|---|---|---|---|---|---|---|
| testing workpiece | a | b | c | d | e | tolerance |
| I | 0.114 | 0.108 | 0.104 | 0.116 | 0.113 | 0.012 |
| II | 0.112 | 0.114 | 0.112 | 0.115 | 0.109 | 0.006 |
| III | 0.107 | 0.113 | 0.105 | 0.113 | 0.110 | 0.006 |
| IV | 0.113 | 0.110 | 0.107 | 0.109 | 0.106 | 0.006 |
| V | 0.112 | 0.117 | 0.111 | 0.111 | 0.112 | 0.006 |
| VI | 0.102 | 0.113 | 0.109 | 0.112 | 0.113 | 0.004 |
| VII | 0.108 | 0.112 | 0.109 | 0.108 | 0.108 | 0.004 |
| VIII | 0.112 | 0.108 | 0.113 | 0.113 | 0.115 | 0.007 |
| IX | 0.109 | 0.109 | 0.116 | 0.115 | 0.117 | 0.008 |
| X | 0.099 | 0.112 | 0.117 | 0.114 | 0.103 | 0.018 |
| XI | 0.108 | 0.116 | 0.112 | 0.109 | 0.107 | 0.009 |
| XII | 0.112 | 0.113 | 0.109 | 0.108 | 0.115 | 0.007 |
| XIII | 0.101 | 0.109 | 0.107 | 0.109 | 0.106 | 0.008 |
| XIV | 0.105 | 0.108 | 0.106 | 0.115 | 0.105 | 0.010 |
| XV | 0.110 | 0.112 | 0.119 | 0.112 | 0.111 | 0.009 |
| XVI | 0.108 | 0.115 | 0.111 | 0.107 | 0.104 | 0.011 |
| XVII | 0.102 | 0.109 | 0.103 | 0.109 | 0.115 | 0.013 |
| XVIII | 0.112 | 0.116 | 0.115 | 0.115 | 0.108 | 0.008 |
| XIX | 0.109 | 0.106 | 0.108 | 0.109 | 0.106 | 0.003 |
| XX | 0.103 | 0.112 | 0.113 | 0.108 | 0.110 | 0.010 |
| maximum | 0.114 | 0.117 | 0.119 | 0.116 | 0.117 | 0.013 |
| minimum | 0.099 | 0.106 | 0.103 | 0.107 | 0.103 | 0.003 |
| tolerance | 0.015 | 0.011 | 0.016 | 0.009 | 0.014 | — |
| average | 0.108 | 0.112 | 0.110 | 0.111 | 0.110 | 0.008 |

In Table 2, the largest tolerance of the etching depths in any one of all the test workpieces 10 is about 0.018 millimeters, and the largest tolerance of the etching depths in all test workpieces 10 is about 0.016 millimeters. Therefore, when the second etchant is used to etch workpieces made of aluminum or an aluminum alloy, the etching quality is well within the allowed tolerances.

A third etchant, in accordance with a third embodiment, is also provided. The third etchant has the same use as the aforementioned first etchant and second etchant. The third etchant includes FeCl₃ solution and HCl. Suitably, the concentration of FeCl₃ is about 70 g/l, and the concentration of HCl is about 50 g/l.

Referring to Table 3, the third etchant is tested to etch twenty test workpieces 10. The areas a, b, c, d and e on the test surface 102 of each test workpiece 10 are etched using the third etchant. The etching process of testing the third etchant has the same equations as those associated with the testing the first etchant and the second etchant. Etching depths in millimeters at each designated location of each test workpiece 10 are described in Table 3, as follows:

TABLE 3

| | place | | | | | |
|---|---|---|---|---|---|---|
| testing workpiece | a | b | c | d | e | tolerance |
| I | 0.108 | 0.103 | 0.114 | 0.108 | 0.123 | 0.020 |
| II | 0.113 | 0.109 | 0.116 | 0.121 | 0.109 | 0.012 |
| III | 0.121 | 0.116 | 0.120 | 0.109 | 0.110 | 0.011 |
| IV | 0.117 | 0.113 | 0.123 | 0.116 | 0.114 | 0.020 |
| V | 0.123 | 0.115 | 0.103 | 0.121 | 0.105 | 0.020 |
| VI | 0.107 | 0.126 | 0.118 | 0.124 | 0.116 | 0.019 |
| VII | 0.105 | 0.122 | 0.113 | 0.120 | 0.114 | 0.017 |
| VIII | 0.116 | 0.113 | 0.127 | 0.116 | 0.115 | 0.014 |
| IX | 0.122 | 0.111 | 0.110 | 0.114 | 0.111 | 0.012 |
| X | 0.117 | 0.109 | 0.117 | 0.112 | 0.116 | 0.008 |
| XI | 0.113 | 0.120 | 0.120 | 0.123 | 0.114 | 0.010 |
| XII | 0.109 | 0.124 | 0.116 | 0.108 | 0.107 | 0.017 |
| XIII | 0.110 | 0.121 | 0.121 | 0.116 | 0.125 | 0.015 |
| XIV | 0.113 | 0.114 | 0.118 | 0.114 | 0.114 | 0.005 |
| XV | 0.122 | 0.116 | 0.116 | 0.119 | 0.116 | 0.006 |
| XVI | 0.123 | 0.111 | 0.115 | 0.115 | 0.113 | 0.012 |
| XVII | 0.114 | 0.108 | 0.114 | 0.112 | 0.114 | 0.006 |
| XVIII | 0.127 | 0.112 | 0.116 | 0.121 | 0.113 | 0.015 |
| XIX | 0.121 | 0.115 | 0.115 | 0.116 | 0.124 | 0.009 |
| XX | 0.118 | 0.109 | 0.109 | 0.106 | 0.108 | 0.012 |
| maximum | 0.127 | 0.126 | 0.127 | 0.124 | 0.125 | 0.020 |
| minimum | 0.105 | 0.103 | 0.103 | 0.106 | 0.105 | 0.005 |
| tolerance | 0.022 | 0.023 | 0.024 | 0.018 | 0.020 | — |
| average | 0.116 | 0.114 | 0.116 | 0.116 | 0.114 | 0.013 |

In Table 3, the largest tolerance of the etching depths in any one of all test workpieces 10 is 0.020 millimeters, and the largest tolerance of the etching depths in all test workpieces 10 is 0.024 millimeters. Therefore, when the third etchant is used to etch workpieces made of aluminum or an aluminum alloy, the etching quality is within acceptable tolerances.

Understandably, as compared to typical etchant, the first etchant, second etchant and third etchant include sufficient amounts of HCl to dissolve the reduced iron powder otherwise formed via the substitution reaction involving the iron ions (Fe³⁺, Fe²⁺) and the aluminum atoms. In this way, the surfaces of the workpieces made of aluminum and/or an aluminum alloy cannot become covered by a layer of iron powder. As such, the etching process can be completed successfully, and the etching quality is improved. Based upon the testing that has been performed, it has been determined that, for the present etchant, it is advantageous that the ferric ions (Fe³⁺) are present in a concentration in the approximate range from 30-70 grams/liter (g/l) and that the hydrochloric acid (HCl) is present in a concentration in the approximate range of 16-50 grams/liter (g/l).

Compared to typical etchant, the present etchant yields include low concentrations of resultant FeCl₃. In this way, the etching process may be more easily regulated. For improving etching efficiency, a surfactant chosen from the group consisting of polyoxyethylene ether, polyvinyl ether, sodium benzenesulfonate and fatty alcohol sulfates, etc, can be added to the present etchant. Additionally, H₂ formed in reaction between HCl and iron powder can be used in other ways (e.g., fuel source, hydrogen source for other reactions), so use of the present etchant has potential additional merit. It is further understood that the present etchant system may have other inherent/latent advantages associated therewith, and such advantages are deemed to be within the scope of the present etchant system.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An etchant comprising:
ferric ions (Fe³⁺) having a concentration in the approximate range of 30-70 grams/liter (g/l); and
hydrochloric acid (HCl) having a concentration in the approximate range of 16-50 grams/liter (g/l).

2. The etchant as claimed in claim 1, wherein the ferric ions (Fe³⁺) have a concentration of 50 grams/liter (g/l).

3. The etchant as claimed in claim 1, wherein the ferric ions (Fe³⁺) have a concentration of roughly 30 grams/liter (g/l).

4. The etchant as claimed in claim 1, wherein the ferric ions (Fe³⁺) have a concentration of roughly 70 grams/liter (g/l).

5. The etchant as claimed in claim 1, wherein the hydrochloric acid (HCl) has a concentration of roughly 30 grams/liter (g/l).

6. The etchant as claimed in claim 1, wherein the hydrochloric acid (HCl) has a concentration of roughly 16 grams/liter (g/l).

7. The etchant as claimed in claim 1, wherein the hydrochloric acid (HCl) has a concentration of roughly 50 grams/liter (g/l).

8. The etchant as claimed in claim 1, wherein the etchant further includes a surfactant.

9. The etchant as claimed in claim 8, wherein the surfactant is chosen from the group consisting of polyoxyethylene ether, polyvinyl ether, sodium benzenesulfonate, and fatty alcohol sulfates.
